(19) United States
(12) Patent Application Publication
(10) Pub. No.: US 2025/0324960 A1
(43) Pub. Date: Oct. 23, 2025

(54) Fishing Stand Assembly

(71) Applicant: Jaime Hebler, Hillman, MN (US)

(72) Inventor: Jaime Hebler, Hillman, MN (US)

(21) Appl. No.: 18/639,656

(22) Filed: Apr. 18, 2024

(51) Int. Cl. A01K 97/01

(52) U.S. Cl. CPC A01K 97/01

(57) ABSTRACT

A fishing stand assembly for indicating that a fish is pulling on a fishing line and facilitating capture of the fish with a fishing rod includes a rattle wheel mount coupled to a board. A rattle wheel is rotatably coupled to the rattle wheel mount. A rattle wheel line is outwardly extendable from the rattle wheel. A fishing pole mount is coupled to the board. The fishing pole mount includes a chamber. A fishing pole is removably positionable in the chamber. The fishing pole includes a grip, a fishing rod, and a fishing line. A bobber is coupled to the fishing line. A line clip couples the fishing line to the rattle wheel line. The bobber contacts the line clip to secure a position of the rattle wheel line relative to the fishing line wherein extension of the fishing line pulls the rattle wheel line to rotate the rattle wheel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fishing stands and more particularly pertains to a new fishing stand for providing audible indication of a fish pulling on a fishing line and facilitating capture of the fish with a fishing rod.

### (2) Description of Related Art Including Information Disclosed Under 37 CFR 1.97 and 1.98

The prior art relates to fishing stands. Fishing stands are often used to hold a fishing rod near a body of water. Some fishing stands include lights or buzzers that alert the fisher that a fish is pulling on the line. The prior art also discloses rattle wheels, which make noise when a fish bites the line. However, to capture a fish using a rattle wheel, the fisher needs to pull in the line of the rattle wheel using a hand-over-hand method. This hand-over-hand method can be difficult, particularly when the line is wet and slippery or when the fisher lacks the hand strength and dexterity needed to wrestle the fish out of the water. Thus, there is a need for a stand that can attach a rattle wheel line to a fishing pole line to provide an audible alert of a fish pulling a line and to permit the fisher to use the fishing pole to reel in the fish.

### BRIEF SUMMARY OF THE INVENTION

An embodiment of the disclosure meets the needs presented above by generally comprising a board. A rattle wheel mount is coupled to the board. The rattle wheel mount comprises a post extending upwardly from the board and an axle that is coupled to the post. The axle extends outwardly from the post. A rattle wheel is rotatably coupled to the rattle wheel mount wherein the rattle wheel is rotatable around the axle. The rattle wheel audibly emits a noise when the rattle wheel rotates around the axle. A rattle wheel line is positionable within the rattle wheel wherein the rattle wheel line is configured to be outwardly extendable from the rattle wheel when the rattle wheel rotates around the axle. A fishing pole mount is coupled to the board. The fishing pole mount is spaced from the rattle wheel mount. The fishing pole mount comprises a leg that is coupled to and extends upwardly from the board. A chamber is coupled to the leg. The chamber extends outwardly from the leg toward the rattle wheel mount wherein a fishing pole is removably positionable in the chamber. The fishing pole includes a grip that is positionable in the chamber. A fishing rod is coupled to the grip. The fishing rod extends over the board toward the rattle wheel mount when the fishing pole is positioned in the chamber. A fishing line is coupled to the fishing rod. The fishing line is downwardly extendable from the fishing rod. The fishing line is aligned with the rattle wheel line when the grip is positioned in the chamber. A bobber is coupled to the fishing line. A line clip releasably couples the fishing line to the rattle wheel line wherein the fishing line and the rattle wheel line are configured to extend outwardly from the fishing pole and the rattle wheel, respectively, when a fish pulls the fishing line. The bobber contacts the line clip to secure a position of the rattle wheel line relative to the fishing line wherein extension of the fishing line pulls the rattle wheel line to rotate the rattle wheel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a fishing stand assembly according to an embodiment of the disclosure.

FIG. 2 is a front isometric view of an embodiment of the disclosure.

FIG. 3 is an exploded view of an embodiment of the disclosure.

FIG. 4 is a detail view of an embodiment of the disclosure.

FIG. 5 is a front view of an embodiment of the disclosure.

FIG. 6 is a top view of an embodiment of the disclosure.

FIG. 7 is a front isometric view of an embodiment of the disclosure.

FIG. 8 is a rear view of an embodiment of the disclosure.

FIG. 9 is an in-use view of an embodiment of the disclosure.

FIG. 10 is an in-use view of an embodiment of the disclosure.

FIG. 11 is an in-use view of an embodiment of the disclosure.

FIG. 12 is an in-use view of an embodiment of the disclosure.

### DETAILED DESCRIPTION OF THE INVENTION

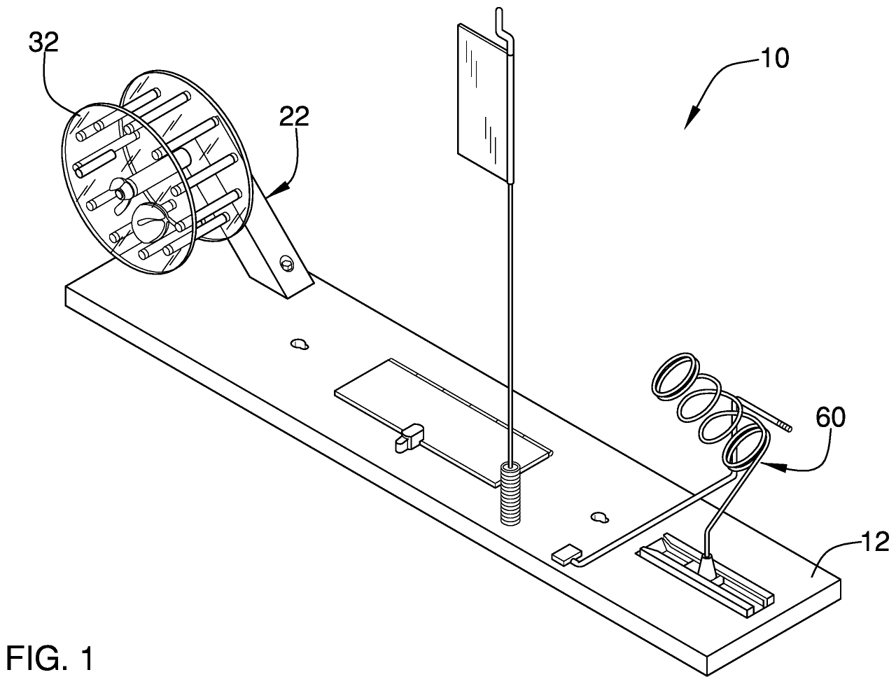

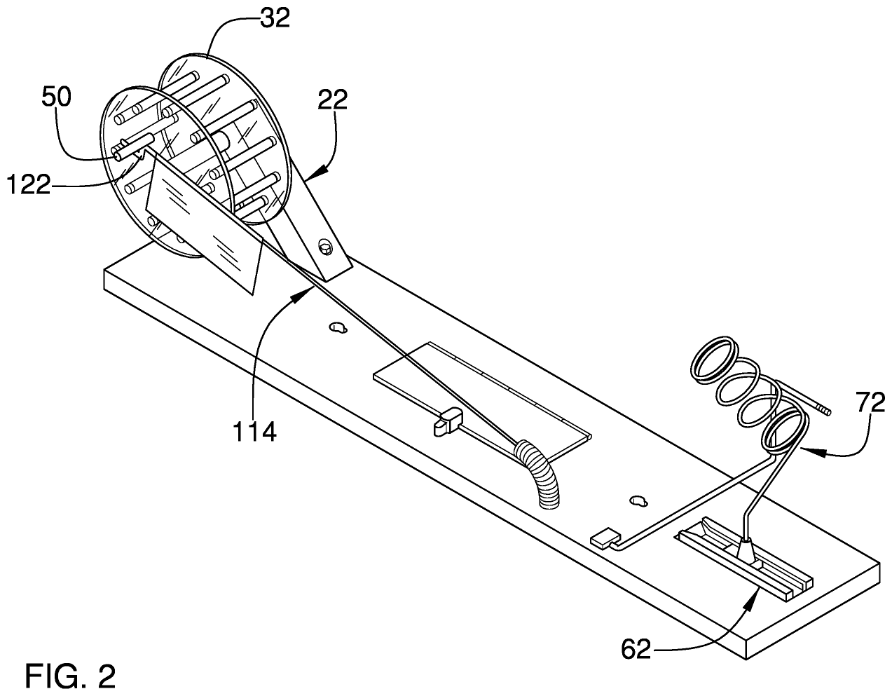

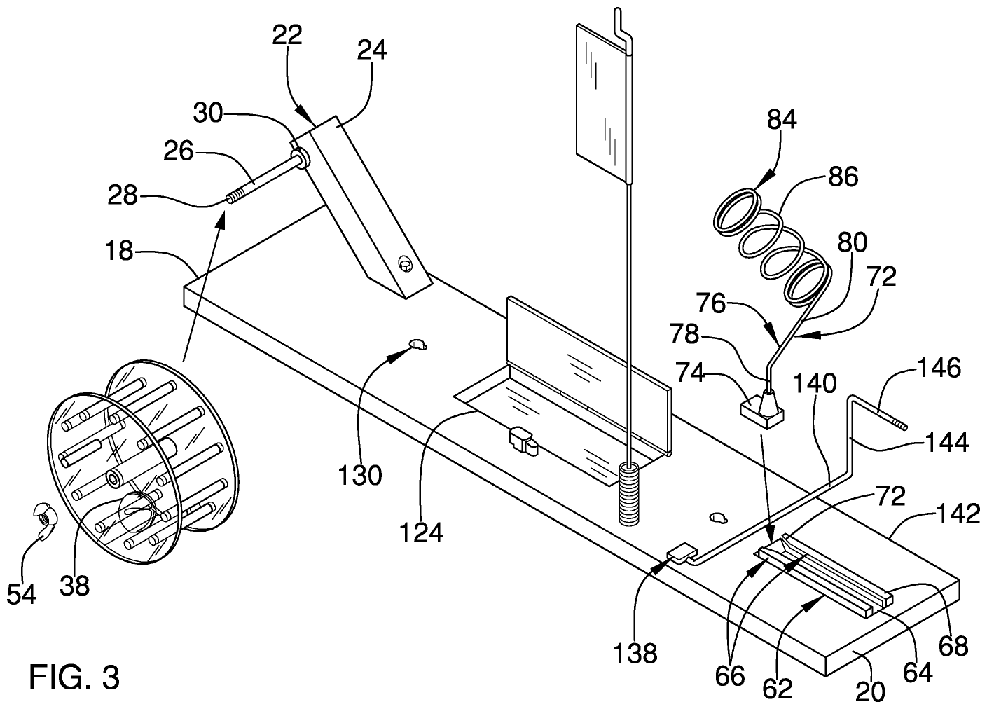

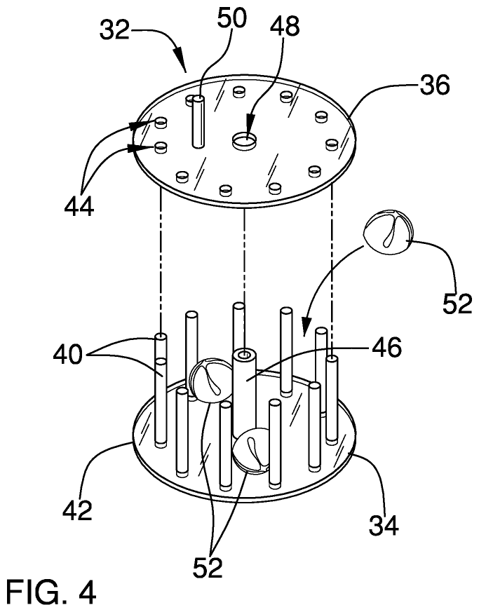

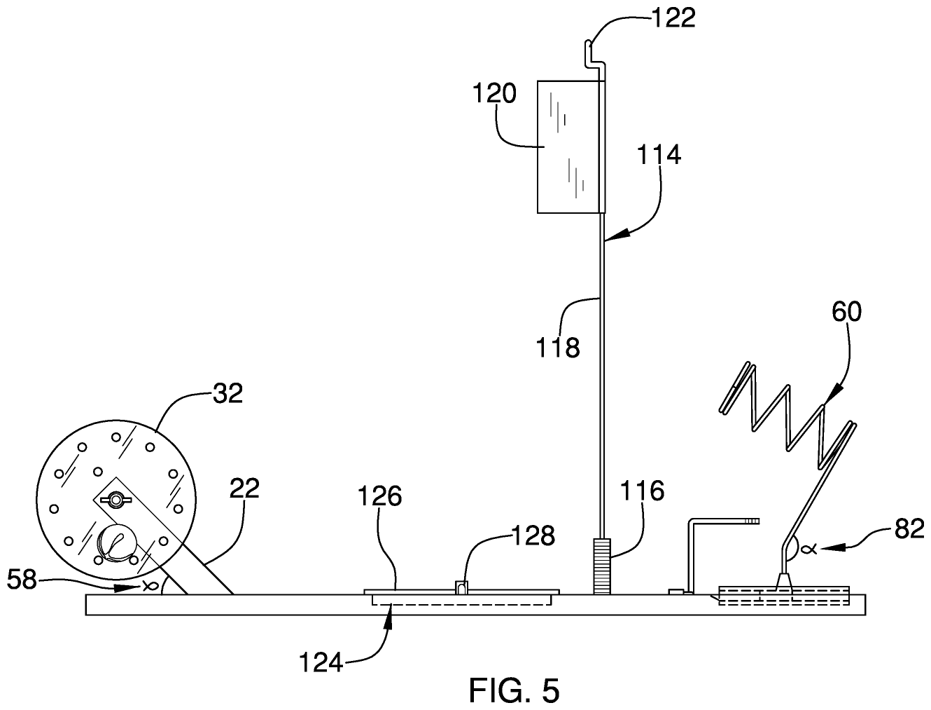

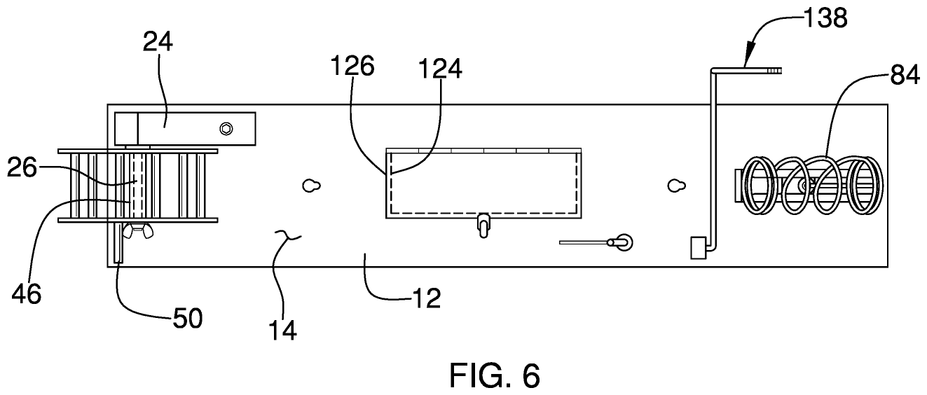

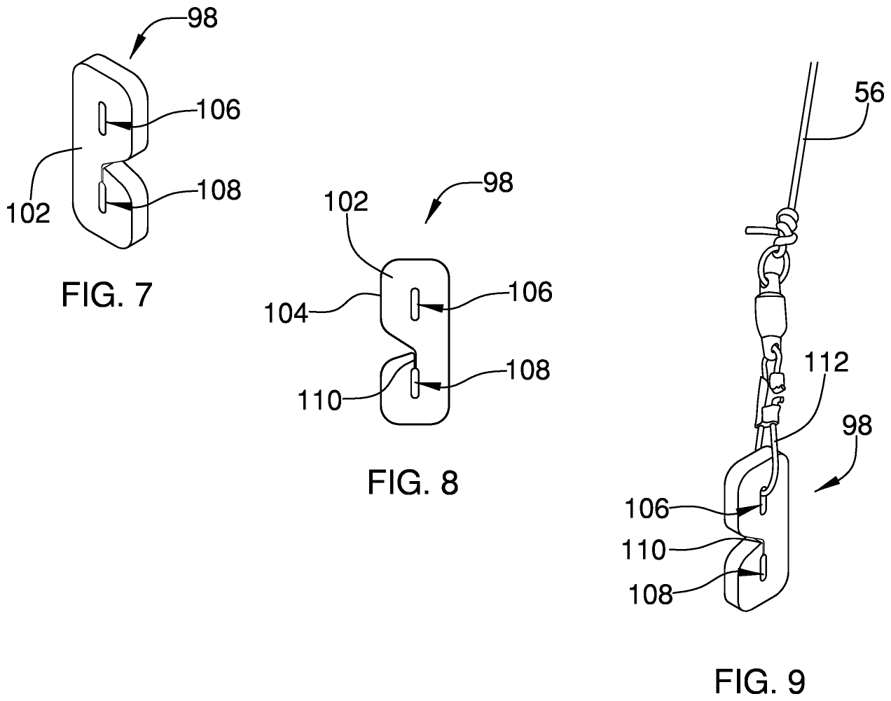

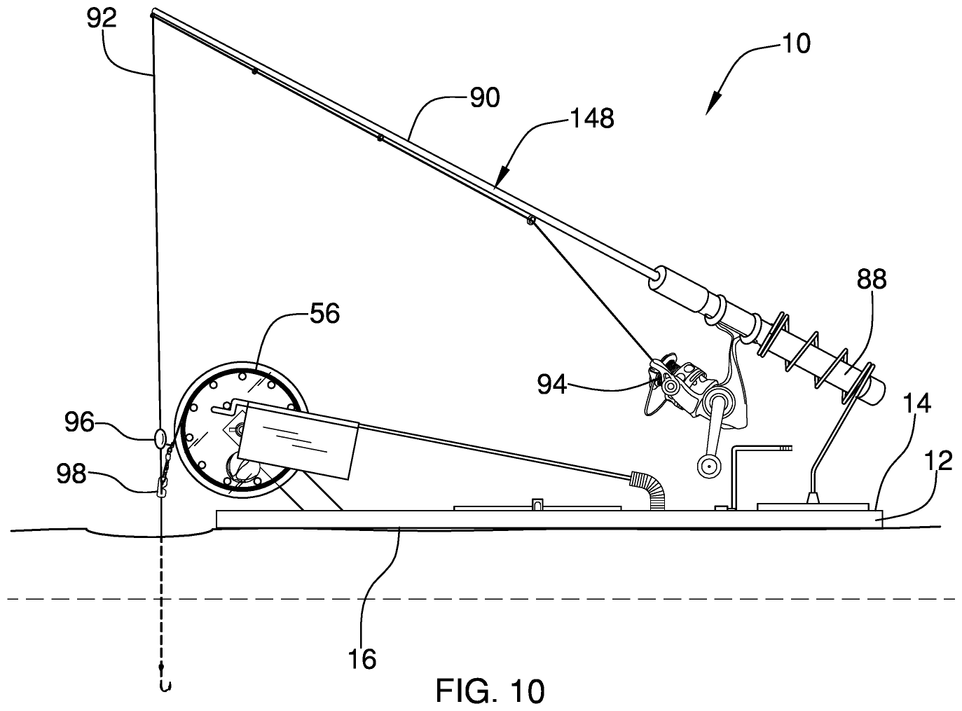

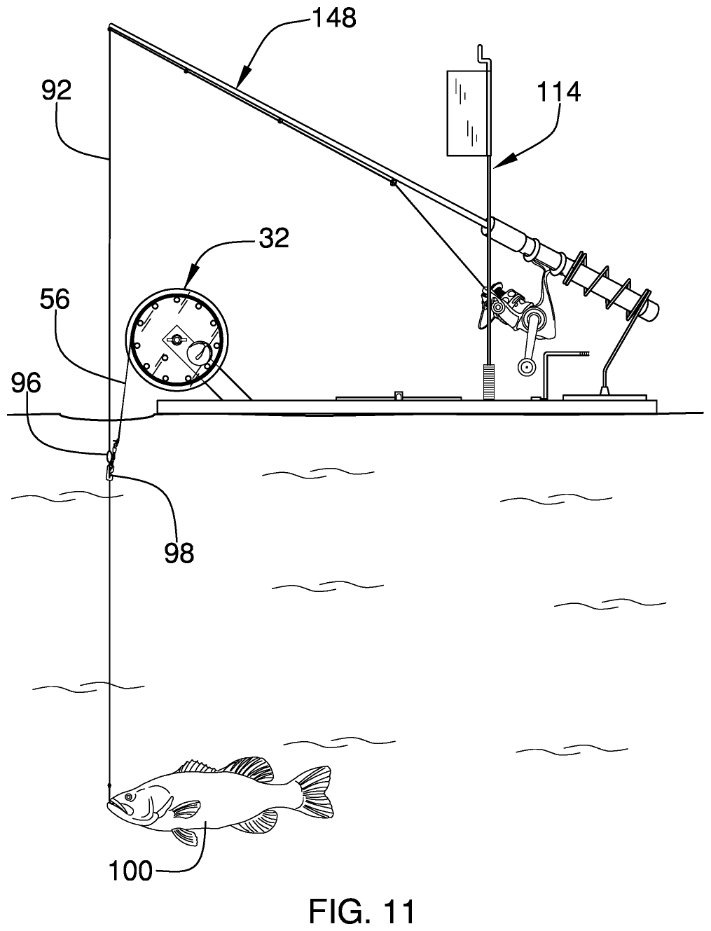

With reference now to the drawings, and in particular to FIGS. 1 through 12 thereof, a new fishing stand embodying the principles and concepts of an embodiment of the disclosure and generally designated by the reference numeral 10 will be described.

As best illustrated in FIGS. 1 through 12, the fishing stand assembly 10 generally comprises a board 12. The board 12 generally has an upper surface 14 and a lower surface 16. The board 12 also generally has a first end 18 and a second end 20. For example, the board 12 may be elongated. The upper surface 14 may be planar, and the lower surface 16 may be planar.

A rattle wheel mount 22 is coupled to the board 12. For example, the rattle wheel mount 22 may be positioned on the upper surface 14 proximate to the first end 18 of the board 12.

The rattle wheel mount 22 may include a post 24 that extends upwardly from the board 12. An axle 26 is coupled to the post 24. The axle 26 generally extends outwardly from the post 24, for example toward the first end 18 of the board 12. The axle 26 may be perpendicular to the post 24. The axle 26 is generally spaced from the upper surface 14 of the board 12. The axle 26 may have a terminal end 28 that is distally positioned on the axle 26 relative to the post 24. The terminal end 28 may be threaded. A spacer 30 may be coupled to the axle 26. The spacer 30 is generally positioned adjacent to the post 24.

A rattle wheel 32 is coupled to the rattle wheel mount 22. The rattle wheel 32 is positioned on the axle 26 wherein the rattle wheel 32 is spaced from the upper surface 14 of the board 12. The rattle wheel 32 is rotatably coupled to the rattle wheel mount 22 wherein the rattle wheel 32 is rotatable around the axle 26. The rattle wheel 32 may be spaced from the post 24 by the spacer 30 wherein the spacer 30 is configured to facilitate rotation of the rattle wheel 32 around the axle 26. The rattle wheel 32 may be removably coupled to the rattle wheel mount 22.

The rattle wheel 32 may comprise a first plate 34. The first plate 34 may be planar, and the first plate 34 may be round. A second plate 36 may be coupled to the first plate 34. The second plate 36 is spaced from the first plate 34. The second plate 36 may be planar, and generally has a shape that is complementary to a shape of the first plate 34. For example, the second plate 36 may be round. The second plate 36 may be removably coupled to the first plate 34. A bell 38 is removably positionable between the first plate 34 and the second plate 36 wherein the bell 38 audibly emits a noise when the rattle wheel 32 rotates around the axle 26.

A plurality of rods 40 may be coupled to and extend outwardly from the first plate 34 to the second plate 36 wherein the plurality of rods 40 is configured to space the first plate 34 from the second plate 36. Each rod of the plurality of rods 40 may be perpendicular to the first plate 34 and the second plate 36. The plurality of rods 40 may be aligned around a perimeter edge 42 of the first plate 34 wherein the plurality of rods 40 is configured to inhibit the bell 38 from falling out of the rattle wheel 32. The plurality of rods 40 may be equidistantly spaced around the perimeter edge 42 of the first plate 34.

A plurality of apertures 44 may extend through the second plate 36. Each aperture of the plurality of apertures 44 is generally alignable with an associated rod of the plurality of rods 40 wherein each aperture of the plurality of apertures 44 receives the associated rod of the plurality of rods 40 to releasably couple the second plate 36 to the first plate 34.

A sleeve 46 may be coupled to the first plate 34 of the rattle wheel 32. The sleeve 46 may extend outwardly from the first plate 34 to the second plate 36. The sleeve 46 is generally hollow wherein the sleeve 46 is configured to receive the axle 26 to couple the rattle wheel 32 to the rattle wheel mount 22. The sleeve 46 may be centrally positioned on the first plate 34.

A hole 48 may extend through the second plate 36. The hole 48 is alignable with the sleeve 46 wherein the hole 48 is configured to receive the sleeve 46 when the second plate 36 is coupled to the first plate 34.

A stem 50 may be coupled to and extend outwardly from the rattle wheel 32. For example, the stem 50 may be positioned on the second plate 36. The stem 50 is generally positioned opposite the second plate 36 from the first plate 34 wherein the stem 50 is parallel to the first end 18 of the board 12 when the rattle wheel 32 is coupled to the rattle wheel mount 22. The stem 50 is generally spaced from the upper surface 14 of the board 12 when the rattle wheel 32 is coupled to the rattle wheel mount 22.

A plurality of additional bells 52 may be removably positionable between the first plate 34 and the second plate 36 wherein the plurality of additional bells 52 alters the noise is emitted by the rattle wheel 32 when the plurality of additional bells 52 is positioned between the first plate 34 and the second plate 36. For example, the plurality of additional bells may be positioned within the rattle wheel 32 when the first plate 34 is removed from the second plate 36.

A retainer 54 may be releasably couplable to the terminal end 28 of the axle 26 of the rattle wheel mount 22. For example, the retainer 54 may be threaded complementary to the terminal end 28 of the axle 26 wherein the retainer 54 is threadably couplable to the axle 26. The axle 26 may have a length exceeding a length of the sleeve 46 of the rattle wheel 32 wherein the terminal end 28 of the axle 26 is exposed when the axle 26 is positioned within the sleeve 46 and wherein the retainer 54 is threadably couplable to the terminal end 28 of the axle 26 to retain the rattle wheel 32 on the axle 26 of the rattle wheel mount 22. The retainer 54 may be positioned adjacent to the second plate 36 when the retainer 54 is threadably coupled to the terminal end 28 of the axle 26 to retain the rattle wheel 32 on the rattle wheel mount 22.

A rattle wheel line 56 is coupled to the rattle wheel 32. For example, the rattle wheel line 56 may be positioned between the first plate 34 and the second plate 36 of the rattle wheel 32. The rattle wheel line 56 may be coiled around the plurality of rods 40 wherein the rattle wheel line 56 is configured to uncoil and extend outwardly from the rattle wheel 32 when the rattle wheel 32 rotates around the axle 26.

The post 24 of the rattle wheel mount 22 may be angled extending away from the upper surface 14 and extending toward the first end 18 of the board 12 to define a post angle 58 between the post 24 and the upper surface 14 of the board 12. For example, the post angle 58 may be between 30.0° and 60.0° wherein the post angle 58 is configured to position the rattle wheel 32 over the first end 18 of the board 12. In certain embodiments, the post angle 58 is 45.0° wherein the post angle 58 is configured to facilitate ease of manufacture.

A fishing pole mount 60 is coupled to the board 12. For example, the fishing pole mount 60 may be positioned on the upper surface 14 proximate to the second end 20 of the board 12 wherein the fishing pole mount 60 is spaced from the rattle wheel mount 22.

The fishing pole mount 60 may include a track 62 that extends toward the first end 18 of the board 12. For example, the track 62 may comprise a channel 64 that extends into the upper surface 14 of the board 12. A pair of bumpers 66 may be coupled to and extend upwardly from the upper surface 14 of the board 12. The pair of bumpers 66 may be positioned on opposing sides of the channel 64. Each bumper of the pair of bumpers 66 may have a length that is coextensive with a length of the channel 64.

For example, each bumper of the pair of bumpers 66 may include a squared portion 68. Each bumper of the pair of bumpers 66 may extend over the channel 64 along the squared portion 68 wherein a width between the pair of bumpers 66 along the squared portion 68 is less than a width of the channel 64. Each bumper of the pair of bumpers 66 may include a tapered portion 68 that extends outwardly from the squared portion 68, for example toward the first end 18 of the board 12, wherein a width between the pair of bumpers 66 along the tapered portion 68 is greater than a width between the pair of bumpers 66 along the squared portion 68.

A fishing pole stand 72 may be movably couplable to the track 62. For example, the fishing pole stand 72 may be slidable along the track 62 wherein a position of the fishing pole stand 72 relative to the track 62 is adjustable to accommodate fishing poles of varying lengths.

The fishing pole stand 72 may comprise a foot 74 that may be removably positionable in the channel 64. For example, the foot 74 may have a width exceeding a width between the pair of bumpers 66 along the squared portion 68 wherein the foot 74 is inhibited from is removed from the channel 64 when the foot 74 is positioned between the squared portion 68 of each of the pair of bumpers 66. The foot 74 may have a width that is smaller than a width of the channel 64 wherein the foot 74 is positionable in the channel 64 between the tapered portion 68 of the pair of bumpers 66.

A leg 76 may be coupled to and extend upwardly from the foot 74. For example, the leg 76 may include a lower portion 78 that may be perpendicular to the foot 74. The leg 76 may also include an upper portion 80 that is coupled to the lower portion 78. The upper portion 80 may be angled to extend upwardly from the lower portion 78 and to extend toward the second end 20 of the board 12 to define a leg angle 82 between the lower portion 78 and the upper portion 80. For example, the leg angle 82 may be between 100.0° and 145.0° such that a fishing pole 148 that is coupled to the fishing pole mount 60 is angled upwardly from the board 12 toward the first end 18 of the board 12.

A chamber 84 may be coupled to the upper portion 80 of the leg 76. The chamber 84 may extend outwardly from the leg 76 toward the first end 18 of the board 12. The chamber 84 may be cylindrical wherein the fishing pole 148 is removably positionable in the chamber 84. In some embodiments, the chamber 84 may have a coil shape 86 wherein a diameter of the chamber 84 is adjustable wherein the fishing pole stand 72 is configured to hold variously sized fishing poles.

The fishing pole 148 generally includes a grip 88 that is removably positionable in the chamber 84. A fishing rod 90 is coupled to and extends outwardly from the grip 88. The fishing rod 90 extends over the board 12 toward the first end 18 of the board 12 when the grip 88 is positioned in the chamber 84. A fishing line 92 is coupled to the fishing rod 90. The fishing line 92 is downwardly extendable from the fishing rod 90 toward the board 12. The fishing line 92 is generally aligned with the rattle wheel line 56 when the grip 88 is positioned in the chamber 84.

A fishing pole reel 94 may be rotatably coupled to the grip 88. The fishing line 92 is coiled around the fishing pole reel 94 wherein the fishing pole reel 94 rotates in a first direction to uncoil the fishing line 92 for extension of the fishing line 92 from the fishing pole reel 94 and wherein the fishing pole reel 94 rotates in a second direction to coil the fishing line 92 around the fishing pole reel 94 for retraction of the fishing line 92 onto the fishing pole reel 94.

A bobber 96 is coupled to the fishing line 92. A line clip 98 releasably couples the fishing line 92 to the rattle wheel line 56 wherein the fishing line 92 and the rattle wheel line 56 are configured to extend outwardly from the fishing pole reel 94 and the rattle wheel 32, respectively, when a fish 100 pulls the fishing line 92. The bobber 96 contacts the line clip 98 to secure a position of the rattle wheel line 56 relative to the fishing line 92. Subsequent extension of the fishing line 92 pulls the rattle wheel line 56 downwardly to rotate the rattle wheel 32, for example when the fishing pole reel 94 rotates in the first direction. The bell 38 of the rattle wheel 32 is configured to audibly emit the noise to provide audible indication of the fish 100 pulling the fishing line 92.

The fishing line 92 may be slidably coupled to the line clip 98 wherein the fishing line 92 is configured to slide downwardly through the line clip 98 when the fish 100 pulls the line and wherein the fishing line 92 is configured to slide upwardly through the line clip 98 when the fishing pole reel 94 is rotated in the second direction to coil the fishing line 92 around the fishing pole reel 94 for retraction of the fishing line 92 onto the fishing pole reel 94. For example, the fishing line 92 may slide upwardly through the line clip 98 when the user reels in the fish 100, such that the user does not need to unclip the fishing line 92 from the line clip 98 before reeling in the fish 100 and such that the user can use the fishing pole 148 to reel in the fish 100 instead of using a hand-over-hand method to capture the fish 100 with the rattle wheel line 56.

The line clip 98 may comprise a hub 102 having an outer edge 104. A rattle wheel line bore 106 may extend through the hub 102. The rattle wheel line bore 106 is generally spaced from the outer edge 104 of the hub 102. A fishing line bore 108 may extend through the hub 102. The fishing line bore 108 may be aligned with the rattle wheel line bore 106. The fishing line bore 108 is generally spaced from the outer edge 104 of the hub 102. The fishing line bore 108 generally has a size that is smaller than a size of the bobber 96 wherein the bobber 96 is inhibited from passing through the fishing line bore 108 when the bobber 96 contacts the line clip 98. A fishing line slit 110 may extend through the outer edge 104 of the hub 102 into the fishing line bore 108 wherein the fishing line 92 is positionable within the fishing line bore 108 through the fishing line slit 110.

A clip hook 112 may couple the rattle wheel line 56 to the line clip 98. For example, the clip hook 112 may extend through the rattle wheel line bore 106 to secure the rattle wheel line 56 to the line clip 98.

A flag 114 may be pivotably coupled to the upper surface 14 of the board 12 wherein the flag 114 is configured to pivot upwardly to provide visual indication of the fish 100 pulling the fishing line 92. The flag 114 may be positioned between the first end 18 and the second end 20 of the board 12, for example, proximate to the fishing pole mount 60.

The flag 114 may include a flag spring 116 that is coupled to and extends upwardly from the board 12. The flag spring 116 may be perpendicular to the board 12 when the flag 114 is pivoted upwardly. A flagpole 118 may be coupled to the flag spring 116. The flagpole 118 generally extends outwardly from the flag spring 116. The flagpole 118 may be perpendicular to the board 12 when the flag 114 is pivoted upwardly. A banner 120 may be coupled to the flagpole 118. The banner 120 is generally distally positioned on the flagpole 118 relative to the board 12.

A finger 122 may be coupled to the flagpole 118. The finger 122 may be positioned above the banner 120. The finger 122 extends outwardly from the flagpole 118 wherein the finger 122 is positionable under the stem 50 of the rattle wheel 32 and wherein the finger 122 is released from under the stem 50 of the rattle wheel 32 when the rattle wheel 32 rotates. The flag 114 pivots upwardly when the finger 122 is released from under the stem 50.

A compartment 124 may be coupled to the board 12. For example, the compartment 124 may be inset into the upper surface 14 of the board 12 wherein the compartment 124 is configured to facilitate storage of the line clip 98. Additionally, the compartment 124 may facilitate storage of the bobber 96, the line clip 98, bait for the fish 100, or other small items that the user commonly uses while fishing. The compartment 124 may be centrally positioned on the board 12.

A compartment lid 126 may be pivotably coupled to the board 12. The compartment lid 126 is positioned adjacent to the compartment 124 wherein the compartment lid 126 is upwardly and downwardly pivotable to selectively open and close the compartment 124.

A compartment latch 128 may be coupled to the board 12. The compartment latch 128 is positioned adjacent to the compartment 124. The compartment latch 128 is alignable with the compartment lid 126. The compartment latch 128 is pivotably coupled to the board 12 wherein the compartment latch 128 pivots over the compartment lid 126 when the compartment lid 126 is pivoted downwardly to close the compartment 124 whereby the compartment latch 128 inhibits the compartment lid 126 from pivoting upwardly to open the compartment 124.

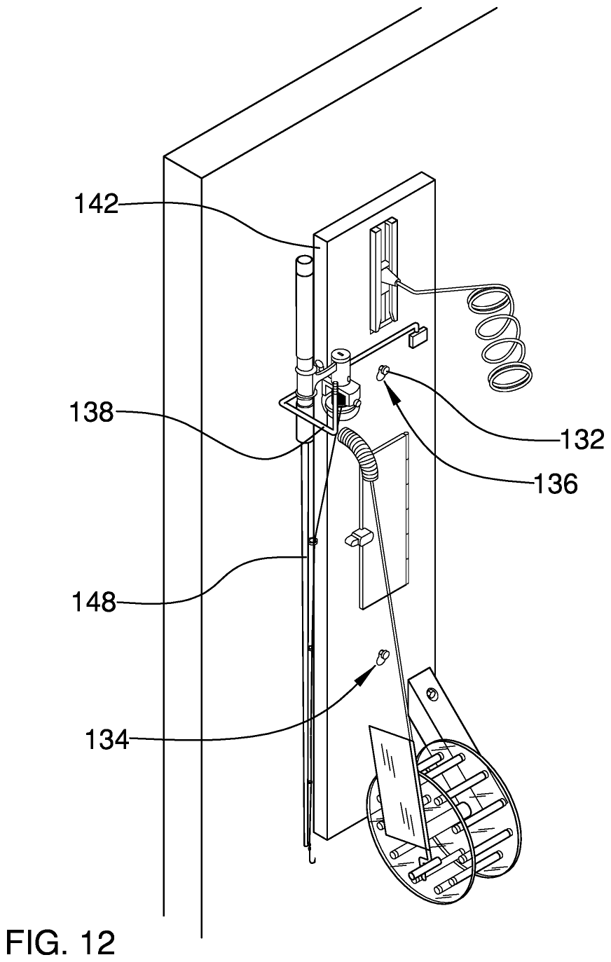

A plurality of notches 130 may extend through the board 12. For example, the plurality of notches 130 may extend into the upper surface 14 and outwardly through the lower surface 16. Each notch of the plurality of notches 130 is generally configured to receive a hanger 132 wherein the plurality of notches 130 is configured to facilitate mounting the board 12 on the hanger 132 for storage of the board 12. For example, the hanger 132 may be a nail extending outwardly from a wall, as shown in FIG. 12.

The plurality of notches 130 may include a first notch 134. For example, the first notch 134 may be positioned between the rattle wheel mount 22 and the compartment 124. A second notch 136 may be positioned between the fishing pole mount 60 and the compartment 124. The second notch 136 may be aligned with the first notch 134.

A holder 138 may be coupled to the board 12. The holder 138 is couplable to the fishing pole 148 wherein the holder 138 is configured to hold the fishing pole 148 when the board 12 is in storage, as shown in FIG. 12. The holder 138 may be positioned adjacent to the fishing pole mount 60.

Embodiments of the holder 138 may include a lower horizontal rib 140 that extends outwardly past a lateral edge 142 of the board 12. The lower horizontal rib 140 may be positioned adjacent to the upper surface 14 of the board 12. The lower horizontal rib 140 may be perpendicular to the channel 64 of the track 62 of the fishing pole mount 60. A vertical rib 144 may be coupled to the lower horizontal rib 140. The vertical rib 144 is generally perpendicular to the lower horizontal rib 140. The vertical rib 144 may be spaced from the lateral edge 142 of the board 12. An upper horizontal rib 146 may be coupled to the vertical rib 144 distally to the lower horizontal rib 140. The upper horizontal rib 146 is generally perpendicular to the vertical rib 144. The upper horizontal rib 146 may extend outwardly from the vertical rib 144 toward the second end 20 of the board 12.

The fishing pole 148 is generally positionable on the holder 138 to rest on the vertical rib 144 when the board 12 is in storage. The upper horizontal rib 146 inhibits the fishing pole 148 from falling off of the holder 138 when the fishing pole 148 rests on the vertical rib 144.

In use, the fishing stand assembly 10 can be positioned adjacent to a body of water. For example, the fishing stand assembly 10 may be positioned on top of a surface of ice adjacent to an ice fishing hole. The first end 18 of the board 12 is positioned adjacent to the ice fishing hole such that the rattle wheel line 56 and the fishing line 92 are extendable into the water. When a fish pulls on the fishing line 92, the fishing line 92 extends downwardly until the bobber 96 contacts the line clip 98. The fishing line 92 and rattle wheel line 56 extend downwardly into the water as the fish 100 pulls on the fishing line 92, causing the rattle wheel 32 to rotate. As the rattle wheel 32 rotates, the bell 38 rings and emits the audible noise to alert the user that the fish 100 is pulling the fishing line 92. Rotation of the rattle wheel 32 also releases the flag 114, which pivots upward to provide visual indication of the fish 100 pulling the fishing line 92. The user can remove the fishing pole 148 from the fishing pole mount 60 and use the fishing pole reel 94 to retract the fishing line 92 and capture the fish 100.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fishing stand comprising:
a board;
a rattle wheel mount being coupled to the board, the rattle wheel mount comprising:
a post extending upwardly from the board;
an axle being coupled to the post, the axle extending outwardly from the post;
a rattle wheel being rotatably coupled to the rattle wheel mount wherein the rattle wheel is rotatable around the axle, the rattle wheel audibly emitting a noise when the rattle wheel rotates around the axle;
a rattle wheel line being positionable within the rattle wheel wherein the rattle wheel line is configured to be outwardly extendable from the rattle wheel when the rattle wheel rotates around the axle;
a fishing pole mount being coupled to the board, the fishing pole mount being spaced from the rattle wheel mount, the fishing pole mount comprising:
a leg being coupled to and extending upwardly from the board;
a chamber being coupled to the leg, the chamber extending outwardly from the leg toward the rattle wheel mount wherein a fishing pole is removably positionable in the chamber;
the fishing pole including:
a grip being positionable in the chamber;
a fishing rod being coupled to the grip, the fishing rod extending over the board toward the rattle wheel mount when the fishing pole is positioned in the chamber;
a fishing line being coupled to the fishing rod, the fishing line being downwardly extendable from the fishing rod, the fishing line being aligned with the rattle wheel line when the grip is positioned in the chamber;
a bobber being coupled to the fishing line; and
a line clip releasably coupling the fishing line to the rattle wheel line wherein the fishing line and the rattle wheel line are configured to extend outwardly from the fishing pole and the rattle wheel, respectively, when a fish pulls the fishing line, the bobber contacting the line clip to secure a position of the rattle wheel line relative to the fishing line wherein extension of the fishing line pulls the rattle wheel line to rotate the rattle wheel.

2. The fishing stand of claim 1, wherein the board has a first end and a second end, the rattle wheel mount being positioned proximate to the first end, the fishing pole mount being positioned proximate to the second end.

3. The fishing stand of claim 2, the leg of the fishing pole mount further comprising:
a lower portion being perpendicular to the board; and
an upper portion being coupled to the lower portion, the upper portion being angled extending upwardly from the lower portion and extending toward the second end of the board, the chamber being coupled to the upper portion of the leg.

4. The fishing stand of claim 1, the rattle wheel mount further comprising a post extending upwardly from the board, the axle being coupled to the post, the post being angled extending away from an upper surface of the board and extending toward a first end of the board wherein the post positions the rattle wheel over the first end of the board.

5. The fishing stand of claim 4, further comprising:
a terminal end of the axle being distally positioned on the axle relative to the post, the terminal end being threaded;
a retainer being releasably couplable to the terminal end of the axle of the rattle wheel mount, the retainer being threaded complementary to the terminal end of the axle wherein the retainer is threadably couplable to the axle; and
the rattle wheel being removably coupled to the rattle wheel mount wherein the axle having a length exceeding a width of the rattle wheel wherein the terminal end of the axle is exposed when the rattle wheel is positioned on the axle and wherein the retainer is threadably couplable to the terminal end of the axle to retain the rattle wheel on the axle of the rattle wheel mount.

6. The fishing stand of claim 5, the rattle wheel further comprising:
a first plate;
a second plate being coupled to the first plate, the second plate being spaced from the first plate, the second plate being removably coupled to the first plate;
a bell being removably positionable between the first plate and the second plate wherein the bell audibly emits the noise when the rattle wheel rotates around the axle; and
a plurality of additional bells being removably positionable between the first plate and the second plate wherein the plurality of additional bells alters the noise being emitted by the rattle wheel when the plurality of additional bells is positioned between the first plate and the second plate.

7. The fishing stand of claim 1, further comprising a flag being pivotably coupled to the board wherein the flag is configured to pivot upwardly to provide visual indication of the fish pulling the fishing line.

8. The fishing stand of claim 7, further comprising:
a stem being coupled to and extending outwardly from the rattle wheel;
a flag spring being coupled to and extending upwardly from the board;
a flagpole being coupled to the flag spring, the flagpole extending outwardly from the flag spring; and
a finger being coupled to the flagpole, the finger extending outwardly from the flagpole wherein the finger is positionable under the stem and wherein the finger is released from under the stem when the rattle wheel rotates, the flag pivoting upwardly when the finger is released from under the stem.

9. The fishing stand of claim 1, the fishing pole mount further comprising:
a track; and
a fishing pole stand being movably couplable to the track, the fishing pole stand being slidable along the track wherein a position of the fishing pole stand relative to the track is adjustable.

10. The fishing stand of claim 9, the track further comprising:
a channel extending into the board; and
a pair of bumpers being coupled to and extending upwardly from the board, the pair of bumpers being positioned on opposing sides of the channel.

11. The fishing stand of claim 10, each bumper of the pair of bumpers further comprising:
a squared portion, each bumper of the pair of bumpers extending over the channel along the squared portion wherein a width between the pair of bumpers along the squared portion is less than a width of the channel; and
a tapered portion extending outwardly from the squared portion toward the first end of the board wherein a width between the pair of bumpers along the tapered portion is greater than a width between the pair of bumpers along the squared portion.

12. The fishing stand of claim 11, the fishing pole stand further comprising:
a foot being removably positionable in the channel, the foot having a width exceeding a width between the pair of bumpers along the squared portion wherein the foot is inhibited from being removed from the channel when the foot is positioned between the squared portion of each of the pair of bumpers, the foot having a width being smaller than a width of the channel wherein the foot is positionable in the channel between the tapered portion of the pair of bumpers; and
the leg being coupled to and extending upwardly from the foot.

13. The fishing stand of claim 1, wherein the chamber has a coil shape wherein a diameter of the chamber is adjustable.

14. The fishing stand of claim 1, the line clip further comprising:
a hub having an outer edge;
a rattle wheel line bore extending through the hub, the rattle wheel line bore being spaced from the outer edge of the hub; and
a fishing line bore extending through the hub, the fishing line bore being aligned with the rattle wheel line bore, the fishing line bore being spaced from the outer edge of the hub, the fishing line bore having a size being smaller than a size of the bobber wherein the bobber is inhibited from passing through the fishing line bore when the bobber contacts the line clip.

15. The fishing stand of claim 14, the line clip further comprising a fishing line slit extending through the outer edge of the hub into the fishing line bore wherein the fishing line is positionable within the fishing line bore through the fishing line slit.

16. A fishing stand comprising:
a board having an upper surface and a lower surface, the board having a first end and a second end, the board being elongated, the upper surface being planar, the lower surface being planar;
a rattle wheel mount being coupled to the upper surface of the board, the rattle wheel mount being positioned proximate to the first end of the board, the rattle wheel mount comprising:
a post extending upwardly from the board;
an axle being coupled to the post, the axle extending outwardly from the post, the axle being perpendicular to the post, the axle being spaced from the upper surface of the board, the axle having a terminal end being distally positioned on the axle relative to the post, the terminal end being threaded;
a spacer being coupled to the axle, the spacer being positioned adjacent to the post;
a rattle wheel being coupled to the rattle wheel mount, the rattle wheel being positioned on the axle wherein the rattle wheel is spaced from the upper surface of the board, the rattle wheel being rotatably coupled to the rattle wheel mount wherein the rattle wheel is rotatable around the axle, the rattle wheel being spaced from the post by the spacer wherein the spacer is configured to facilitate rotation of the rattle wheel around the axle, the rattle wheel being removably coupled to the rattle wheel mount, the rattle wheel comprising:
a first plate, the first plate being planar, the first plate being round;
a second plate being coupled to the first plate, the second plate being spaced from the first plate, the second plate being planar, the second plate being round, the second plate being removably coupled to the first plate;
a bell being removably positionable between the first plate and the second plate wherein the bell audibly emits a noise when the rattle wheel rotates around the axle;
a plurality of rods being coupled to and extending outwardly from the first plate to the second plate wherein the plurality of rods is configured to space the first plate from the second plate, each rod of the plurality of rods being perpendicular to the first plate and the second plate, the plurality of rods being aligned around a perimeter edge of the first plate wherein the plurality of rods is configured to inhibit the bell from falling out of the rattle wheel, the plurality of rods being equidistantly spaced around the perimeter edge of the first plate;
a plurality of apertures extending through the second plate, each aperture of the plurality of apertures being alignable with an associated rod of the plurality of rods wherein each aperture of the plurality of apertures receives the associated rod of the plurality of rods to releasably couple the second plate to the first plate;
a sleeve being coupled to the first plate, the sleeve extending outwardly from the first plate to the second plate, the sleeve being hollow wherein the sleeve is configured to receive the axle to couple the rattle wheel to the rattle wheel mount, the sleeve being centrally positioned on the first plate;
a hole extending through the second plate, the hole being alignable with the sleeve wherein the hole is configured to receive the sleeve when the second plate is coupled to the first plate;
a stem being coupled to and extending outwardly from the second plate, the stem being positioned opposite the second plate from the first plate wherein the stem is parallel to the first end of the board when the rattle wheel is coupled to the rattle wheel mount, the stem being spaced from the upper surface of the board when the rattle wheel is coupled to the rattle wheel mount;
a plurality of additional bells being removably positionable between the first plate and the second plate wherein the plurality of additional bells alters the noise being emitted by the rattle wheel when the plurality of additional bells is positioned between the first plate and the second plate;
a retainer being releasably couplable to the terminal end of the axle of the rattle wheel mount, the retainer being threaded complementary to the terminal end of the axle wherein the retainer is threadably couplable to the axle, the axle having a length exceeding a length of the sleeve of the rattle wheel wherein the terminal end of the axle is exposed when the axle is positioned within the sleeve and wherein the retainer is threadably couplable to the terminal end of the axle to retain the rattle wheel on the axle of the rattle wheel mount, the retainer being positioned adjacent to the second plate when the retainer is threadably coupled to the terminal end of the axle to retain the rattle wheel on the rattle wheel mount;
a rattle wheel line being positioned between the first plate and the second plate of the rattle wheel, the rattle wheel line being coiled around the plurality of rods wherein the rattle wheel line is configured to uncoil and extend outwardly from the rattle wheel when the rattle wheel rotates around the axle;
the post of the rattle wheel mount being angled extending away from the upper surface and extending toward the first end of the board to define a post angle between the post and the upper surface of the board, the post angle being between 30.0° and 60.0° wherein the post angle is configured to position the rattle wheel over the first end of the board;
a fishing pole mount being coupled to the upper surface of the board, the fishing pole mount being positioned proximate to the second end of the board wherein the fishing pole mount is spaced from the rattle wheel mount, the fishing pole mount comprising:
a track extending toward the first end of the board, the track comprising:
a channel extending into the upper surface of the board;
a pair of bumpers being coupled to and extending upwardly from the upper surface, the pair of bumpers being positioned on opposing sides of the channel, the pair of bumpers having a length being coextensive with a length of the channel, each bumper of the pair of bumpers including:
a squared portion, each bumper of the pair of bumpers extending over the channel along the squared portion wherein a width between the pair of bumpers along the squared portion is less than a width of the channel;
a tapered portion extending outwardly from the squared portion toward the first end of the board wherein a width between the pair of bumpers along the tapered portion is greater than a width between the pair of bumpers along the squared portion;
a fishing pole stand being movably couplable to the track, the fishing pole stand being slidable along the track wherein a position of the fishing pole stand relative to the track is adjustable, the fishing pole stand comprising:
a foot being removably positionable in the channel, the foot having a width exceeding a width between the pair of bumpers along the squared portion wherein the foot is inhibited from being removed from the channel when the foot is positioned between the squared portion of each of the pair of bumpers, the foot having a width being smaller than a width of the channel wherein the foot is positionable in the channel between the tapered portion of the pair of bumpers;
a leg being coupled to and extending upwardly from the foot, the leg including:
a lower portion being perpendicular to the foot;
an upper portion being coupled to the lower portion, the upper portion being angled extending upwardly from the lower portion and extending toward the second end of the board to define a leg angle between the lower portion and the upper portion, the leg angle being between 100.0° and 145.0°;
a chamber being coupled to the upper portion of the leg, the chamber extending outwardly from the leg toward the first end of the board, the chamber being cylindrical wherein a fishing pole is removably positionable in the chamber, the chamber being a coil shape wherein a diameter of the chamber is adjustable;
the fishing pole including:
a grip being removably positionable in the chamber;
a fishing rod being coupled to and extending outwardly from the grip, the fishing rod extending over the board toward the first end of the board when the grip is positioned in the chamber;
a fishing line being coupled to the fishing rod, the fishing line extending downwardly from the fishing rod toward the board, the fishing line being aligned with the rattle wheel line when the grip is positioned in the chamber;
a fishing pole reel being rotatably coupled to the grip, the fishing line being coiled around the fishing pole reel wherein the fishing pole reel rotates in a first direction to uncoil the fishing line for extension of the fishing line from the fishing pole reel and wherein the fishing pole reel rotates in a second direction to coil the fishing line around the fishing pole reel for retraction of the fishing line onto the fishing pole reel;
a bobber being coupled to the fishing line;
a line clip releasably coupling the fishing line to the rattle wheel line wherein the fishing line and the rattle wheel line are configured to extend outwardly from the fishing pole reel and the rattle wheel, respectively, when a fish pulls the fishing line, the bobber contacting the line clip to secure a position of the rattle wheel line relative to the fishing line wherein extension of the fishing line pulls the rattle wheel line downwardly to rotate the rattle wheel when the fishing pole reel rotates in the first direction and wherein the bell of the rattle wheel is configured to audibly emit the noise to provide audible indication of the fish pulling the fishing line, the fishing line being slidably coupled to the line clip wherein the fishing line is configured to slide downwardly through the line clip when the fish pulls the line and wherein the fishing line is configured to slide upwardly through the line clip when the fishing pole reel is rotated in the second direction to coil the fishing line around the fishing pole reel for retraction of the fishing line onto the fishing pole reel, the line clip comprising:
a hub having an outer edge;
a rattle wheel line bore extending through the hub, the rattle wheel line bore being spaced from the outer edge of the hub;
a fishing line bore extending through the hub, the fishing line bore being aligned with the rattle wheel line bore, the fishing line bore being spaced from the outer edge of the hub, the fishing line bore having a size being smaller than a size of the bobber wherein the bobber is inhibited from passing through the fishing line bore when the bobber contacts the line clip;
a fishing line slit extending through the outer edge of the hub into the fishing line bore wherein the fishing line is positionable within the fishing line bore through the fishing line slit;
a clip hook coupling the rattle wheel line to the line clip, the clip hook extending through the rattle wheel line bore to secure the rattle wheel line to the line clip;
a flag being pivotably coupled to the upper surface of the board wherein the flag is configured to pivot upwardly to provide visual indication of the fish pulling the fishing line, the flag being positioned proximate to the fishing pole mount between the first end and the second end of the board, the flag including:
a flag spring being coupled to and extending upwardly from the board, the flag spring being perpendicular to the board when the flag is pivoted upwardly;
a flagpole being coupled to the flag spring, the flagpole extending outwardly from the flag spring, the flagpole being perpendicular to the board when the flag is pivoted upwardly;
a banner being coupled to the flagpole, the banner being distally positioned on the flagpole relative to the board;
a finger being coupled to the flagpole, the finger being positioned above the banner, the finger extending outwardly from the flagpole wherein the finger is positionable under the stem of the rattle wheel and wherein the finger is released from under the stem of the rattle wheel when the rattle wheel rotates, the flag pivoting upwardly when the finger is released from under the stem;
a compartment being coupled to the board, the compartment being inset into the upper surface of the board wherein the compartment is configured to facilitate storage of the line clip, the compartment being centrally positioned on the board;
a compartment lid being pivotably coupled to the board, the compartment lid being positioned adjacent to the compartment wherein the compartment lid is upwardly and downwardly pivotable to selectively open and close the compartment;
a compartment latch being coupled to the board, the compartment latch being positioned adjacent to the compartment, the compartment latch being alignable with the compartment lid, the compartment latch being pivotably coupled to the board wherein the compartment latch pivots over the compartment lid when the compartment lid is pivoted downwardly to close the compartment whereby the compartment latch inhibits the compartment lid from being pivoted upwardly to open the compartment;
a plurality of notches extending through the board, each notch of the plurality of notches being configured to receive a hanger wherein the plurality of notches is configured to facilitate mounting the board on the hanger for storage of the board, the plurality of notches including:
a first notch being positioned between the rattle wheel mount and the compartment;
a second notch being positioned between the fishing pole mount and the compartment, the second notch being aligned with the first notch;
a holder being coupled to the board, the holder being couplable to the fishing pole wherein the holder is configured to hold the fishing pole when the board is in storage, the holder being positioned adjacent to the fishing pole mount, the holder including:
a lower horizontal rib extending outwardly past a lateral edge of the board, the lower horizontal rib being positioned adjacent to the upper surface of the board, the lower horizontal rib being perpendicular to the channel of the track of the fishing pole mount;
a vertical rib being coupled to the lower horizontal rib, the vertical rib being perpendicular to the lower horizontal rib, the vertical rib being spaced from the lateral edge of the board;
an upper horizontal rib being coupled to the vertical rib distally to the lower horizontal rib, the upper horizontal rib being perpendicular to the vertical rib, the upper horizontal rib extending outwardly from the vertical rib toward the second end of the board;
wherein the fishing pole is positionable on the holder to rest on the vertical rib when the board is in storage and wherein the upper horizontal rib inhibits the fishing pole from falling off of the holder when the fishing pole rests on the vertical rib.
